(19) United States
(12) Patent Application Publication
(10) Pub. No.: US 2015/0195322 A1
(43) Pub. Date: Jul. 9, 2015

(54) Media Resource Playback Method and System

(71) Applicant: Huawei Device Co., Ltd., Shenzhen (CN)

(72) Inventors: Zhenwei Shan, Shenzhen (CN); Yu Zhu, Shenzhen (CN)

(21) Appl. No.: 14/662,981

(22) Filed: Mar. 19, 2015

Related U.S. Application Data
(63) Continuation of application No. PCT/CN2012/081682, filed on Sep. 20, 2012.

(51) Int. Cl. H04L 29/06; G06F 9/44; G06F 17/30

(52) U.S. Cl. CPC H04L 65/60; G06F 17/30864; G06F 9/4418

(57) ABSTRACT

A media resource playback method, including aggregating, by an aggregate server, media resource information of media servers in a local area network and sleep state information of a media server in sleep state, and generating a media resource directory according to the media resource information or according to both the media resource information and the sleep state information; receiving a browse or search request sent by a control point, and returning content in the media resource directory to the control point; determining, by the aggregate server according to the sleep state information, that a media server storing a to-be-played media resource is in sleep state; and waking up the media server, so that a media playback device acquires the to-be-played media resource from the media server and plays the to-be-played media resource.

### CROSS-REFERENCE TO RELATED APPLICATIONS

This application is a continuation of International Application No. PCT/CN2012/081682, filed on Sep. 20, 2012, which is incorporated herein by reference in its entirety.

### TECHNICAL FIELD

The present invention relates to the field of multimedia technologies, and in particular, to a media resource playback method and system.

### BACKGROUND

With the development of digital technologies and consumer electronics, more and more digital entertainment devices and home appliance products find use in individual homes. These digital entertainment devices and home appliance products are connected into a home network via a wired connection or wirelessly, to implement functions such as content sharing or mutual control, thereby moving towards the industry goal of turning a digital home network to be a part of daily life. In the prior art, in order to achieve interworking and control between various devices of different types, devices in a home network need to support Universal Plug and Play (UPnP). In a UPnP system, a user controls various devices using a control point (CP) in a home network, and the CP invokes a related control command for a UPnP device according to the UPnP protocol to read state information of the UPnP device in the home network and to control the UPnP device to execute a corresponding operation.

In a scenario of media sharing between multiple devices in a home network, there is generally involved a media server (MS), a media renderer (MR), and an audio video CP, where the media server is configured to store a media resource, the media renderer is configured to play a media resource, and the audio video CP is configured to control entities of the foregoing two devices. The audio video CP browses a media resource in the MS, and sends a request of playing the media resource to the MR, so that the MR plays the media resource in the MS. To conserve device power, the UPnP Protocol defines an energy-efficient architecture in which multiple types of energy-saving states are defined, and when multiple MSs are not running, an energy-saving state can be entered. In the prior art, an aggregate server further exists, and can be used to aggregate media content in all MSs in a local area network. When entering an energy-saving state, an MS reports its sleep state information to the aggregate server. At present, the only way for a CP to access resources aggregated in the aggregate server is to send a browse request or a search request. When accessing the aggregate server in such a way, the CP selects one of the media resources and sends information about the media resource, such as address information to the MR, and then the MR requests the resource from a corresponding MS according to the information. When the MS is in sleep state, the MR is unable to obtain the corresponding media resource, and consequently the playback fails.

### SUMMARY

Embodiments of the present invention provide a media resource playback method and system, so that a media server that needs to be woken up can be determined according to media resource information and sleep state information that are aggregated by an aggregate server, and the media server can be woken up by the aggregate server or a control point, to complete a corresponding playback process.

A first aspect of the present invention provides a media resource playback method, which may include aggregating, by an aggregate server, media resource information of media servers in a local area network and sleep state information of a media server in sleep state, and generating a media resource directory according to the media resource information or according to both the media resource information and the sleep state information; receiving a browse or search request sent by a control point, and returning content in the media resource directory to the control point, and if the aggregate server receives a media resource selection request or a media server wakeup request sent by the control point, or if the aggregate server receives a media resource acquisition request or a media server address query request sent by a media playback device, determining, by the aggregate server according to the sleep state information, that a media server storing a to-be-played media resource is in sleep state; and waking up the media server, so that the media playback device acquires the to-be-played media resource from the media server and plays the to-be-played media resource.

In a first possible implementation, a method for waking up the media server by the aggregate server may include setting a virtual uniform resource locator for a media resource in the aggregated media resource directory, where an internet protocol (IP) address of the virtual uniform resource locator points to the aggregate server; receiving a browse or search request sent by the control point, and returning media resource information that includes a respective virtual uniform resource locator to the control point; and if the control point selects a media resource and sends a virtual uniform resource locator of the media resource to the media playback device to request playing the media resource, receiving, by the aggregate server, a media resource acquisition request sent according to the virtual uniform resource locator by the media playback device; determining, by the aggregate server according to the sleep state information, that a media server storing the media resource is in sleep state; and waking up the media server.

With reference to the first possible implementation of the first aspect, in a second possible implementation, after the waking up the media server by the aggregate server, the method may further include acquiring an actual uniform resource locator of the media resource and sending the actual uniform resource locator of the media resource to the media playback device; and requesting, by the media playback device, the media resource from the media server according to the actual uniform resource locator of the media resource, acquiring the media resource, and playing the media resource.

In a third possible implementation, a method for waking up the media server by the aggregate server may include, if the control point selects a media resource and sends a uniform resource identifier of the media resource to the media playback device to request playing the media resource, receiving, by the aggregate server, an Address Resolution Protocol packet broadcast by the media playback device to the local area network, where the Address Resolution Protocol packet is used to request a media access control (MAC) address of the media server, and the Address Resolution Protocol packet includes an IP address of the media playback device and an IP address of the media server; determining, by the aggregate server according to the sleep state information, that the media server to which the IP address of the media server points is in sleep state; and waking up the media server.

With reference to the third possible implementation of the first aspect, in a fourth possible implementation, after the waking up the media server by the aggregate server, the method may further include sending, by the media server, the MAC address of the media server to the media playback device; and requesting, by the media playback device, the media resource from the media server according to the uniform resource identifier of the media resource, acquiring the media resource, and playing the media resource.

With reference to the third or fourth possible implementation of the first aspect, in a fifth possible implementation, the Address Resolution Protocol packet may further include a MAC address of the media playback device, and the aggregate server determines, according to the MAC address or IP address of the media playback device, whether the Address Resolution Protocol packet is sent by the corresponding media playback device.

With reference to the first aspect or the first or second or third or fourth or fifth possible implementation of the first aspect, in a sixth possible implementation, the media resource information may include a uniform resource identifier of a media resource.

With reference to the first aspect or the first or second or third or fourth or fifth or sixth possible implementation of the first aspect, in a seventh possible implementation, a manner for waking up the media server may include sending a wakeup request to the media server to wake up the media server; or waking up the media server using an out-of-band mechanism of Ethernet wakeup.

A second aspect of the present invention provides a media resource playback method, which may include sending, by a control point, a browse or search request, to acquire content in a media resource directory aggregated in an aggregate server, where the content in the media resource directory includes media resource information of media servers in a local area network and sleep state information of a media server in sleep state; determining, by the control point according to the sleep state information, that a media server storing a to-be-played media resource is in sleep state; and waking up the media server, and controlling a media playback device to acquire the to-be-played media resource from the media server and play the to-be-played media resource.

In a first possible implementation, the browse or search request may include version information of the control point; when a version of the control point provides support for identifying the sleep state information, media resource information of all media servers is acquired, or when the version of the control point does not provide support for identifying the sleep state information, media resource information of a media server not in sleep state is acquired.

With reference to the second aspect or the first possible implementation of the second aspect, in a second possible implementation, the media resource information may include a uniform resource identifier of a media resource.

With reference to the second aspect or the first or second possible implementation of the second aspect, in a third possible implementation, a manner for waking up the media server may include sending a wakeup request to the media server to wake up the media server; or waking up the media server using an out-of-band mechanism of Ethernet wakeup.

A third aspect of the present invention provides a media resource playback method, which may include aggregating, by an aggregate server, media resource information of media servers in a local area network and sleep state information of a media server in sleep state, and generating an aggregated media resource directory according to the media resource information and the sleep state information; and receiving a browse or search request sent by a control point, and returning content in the media resource directory to the control point, where the sleep state information is used to determine, by the control point, that a media server storing a to-be-played media resource is in sleep state, so that the aggregate server can wake up the media server, and control a media playback device to acquire the to-be-played media resource from the media server and play the to-be-played media resource.

In a first possible implementation, the media resource information may include a uniform resource identifier of a media resource.

With reference to the third aspect or the first possible implementation of the third aspect, in a second possible implementation, a manner for waking up the media server may include sending a wakeup request to the media server to wake up the media server; or waking up the media server using an out-of-band mechanism of Ethernet wakeup.

A fourth aspect of the present invention provides a media resource playback system, which may include a media server configured to store a media resource and media resource information; an aggregate server configured to aggregate media resource information of media servers in a local area network and sleep state information of a media server in sleep state, and generate a media resource directory according to the media resource information or according to both the media resource information and the sleep state information; receive a browse or search request sent by a control point, and return the media resource directory to the control point; and if a media resource selection request or a media server wakeup request sent by the control point is received, or if a media resource acquisition request or a media server address query request sent by a media playback device is received, determine, according to the sleep state information, that a media server storing a to-be-played media resource is in sleep state; and wake up the media server, so that the media playback device acquires the to-be-played media resource from the media server and plays the to-be-played media resource; the control point configured to send a browse or search request to the aggregate server, acquire the media resource directory, and send a media resource selection request or a media server wakeup request to the aggregate server; and the media playback device configured to send a media resource acquisition request or a media server address query request to the aggregate server; and acquire the to-be-played media resource from the media server and play the to-be-played media resource.

In a first possible implementation, the aggregate server may be further configured to set a virtual uniform resource locator for a media resource in the aggregated media resource directory, where an IP address of the virtual uniform resource locator points to the aggregate server; receive a browse or search request sent by the control point, and return media resource information that includes a respective virtual uniform resource locator to the control point; and if the control point selects a media resource and sends a virtual uniform resource locator of the media resource to the media playback device to request playing the media resource, receive, by the aggregate server, a media resource acquisition request sent according to the virtual uniform resource locator by the media playback device; determine, according to the sleep state information, that a media server storing the media resource is in sleep state; wake up the media server; and acquire an actual uniform resource locator of the media resource and send the actual uniform resource locator of the media resource to the media playback device; and the media playback device may be further configured to request the media resource from the media server according to the actual uniform resource locator of the media resource, acquire the media resource, and play the media resource.

In a second possible implementation, the aggregate server may be further configured to, if the control point selects a media resource and sends a uniform resource identifier of the media resource to the media playback device to request playing the media resource, receive, by the aggregate server, an Address Resolution Protocol packet broadcast by the media playback device to the local area network, where the Address Resolution Protocol packet is used to request a MAC address of the media server, and the Address Resolution Protocol packet includes an IP address of the media playback device and an IP address of the media server; determine, according to the sleep state information, that the media server to which the IP address of the media server points is in sleep state; and wake up the media server; the media server may be further configured to send the MAC address of the media server to the media playback device; and the media playback device may be further configured to request the media resource from the media server according to the uniform resource identifier of the media resource, acquire the media resource, and play the media resource.

With reference to the second possible implementation of the fourth aspect, in a third possible implementation, the Address Resolution Protocol packet may further include a MAC address of the media playback device, and the aggregate server is further configured to determine, according to the MAC address or IP address of the media playback device, whether the Address Resolution Protocol packet is sent by the corresponding media playback device.

With reference to the fourth aspect or the first or second or third possible implementation of the fourth aspect, in a fourth possible implementation, the media resource information may include a uniform resource identifier of a media resource.

With reference to the fourth aspect or the first or second or third or fourth possible implementation of the fourth aspect, in a fifth possible implementation, a manner for waking up the media server may include sending a wakeup request to the media server to wake up the media server; or waking up the media server using an out-of-band mechanism of Ethernet wakeup.

With reference to the fourth aspect or the first or second or third or fourth or fifth possible implementation of the fourth aspect, in a sixth possible implementation, the control point exists independently or is integrated in the aggregate server.

A fifth aspect of the present invention provides a media resource playback system, which may include a media server configured to store a media resource and media resource information; an aggregate server configured to aggregate media resource information of media servers in a local area network and sleep state information of a media server in sleep state; a control point configured to send a browse or search request to the aggregate server, to acquire content in a media resource directory aggregated in the aggregate server, where the content of the media resource directory includes the media resource information of the media servers in the local area network and the sleep state information of a media server in sleep state; determine, according to the sleep state information, that a media server storing a to-be-played media resource is in sleep state; and wake up the media server, and control the media playback device to acquire the to-be-played media resource from the media server and play the to-be-played media resource; and the media playback device configured to receive a control command sent by the control point, acquire the media resource from the media server, and play the media resource.

In a first possible implementation, the browse or search request may include version information of the control point; when a version of the control point provides support for identifying the sleep state information, the control point is configured to acquire media resource information of all media servers, or when the version of the control point does not provide support for identifying the sleep state information, the control point is configured to acquire media resource information of a media server not in sleep state.

With reference to the fifth aspect or the first possible implementation of the fifth aspect, in a second possible implementation, the media resource information may include a uniform resource identifier of a media resource.

With reference to the fifth aspect or the first or second possible implementation of the fifth aspect, in a third possible implementation, a manner for waking up the media server may include sending a wakeup request to the media server to wake up the media server; or waking up the media server using an out-of-band mechanism of Ethernet wakeup.

The embodiments of the present invention achieve the following beneficial effects when practiced, when various requests from a control point or a media playback device are received, a media server that needs to be woken up can be determined according to media resource information and sleep state information that are aggregated by an aggregate server, and the media server can be woken up by the aggregate server or the control point, to complete a corresponding playback process.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic flowchart illustrating a first embodiment of a media resource playback method according to the present invention;

FIG. 2 is a schematic flowchart illustrating a first embodiment of a method for waking up a media server by an aggregate server according to the present invention;

FIG. 3 is a schematic flowchart illustrating a first embodiment of a method for waking up a media server by an aggregate server and completing playback according to the present invention;

FIG. 4 is a schematic flowchart illustrating a second embodiment of a method for waking up a media server by an aggregate server according to the present invention;

FIG. 5 is a schematic flowchart illustrating a second embodiment of a method for waking up a media server by an aggregate server and completing playback according to the present invention;

FIG. 6 is a schematic flowchart illustrating a second embodiment of a media resource playback method according to the present invention;

FIG. 7 is a schematic flowchart illustrating a third embodiment of a media resource playback method according to the present invention; and

FIG. 8 is a schematic structural diagram of a media resource playback system according to an embodiment of the present invention.

### DESCRIPTION OF EMBODIMENTS

The following clearly describes the technical solutions in the embodiments of the present invention with reference to the accompanying drawings in the embodiments of the present invention. The described embodiments are merely some but not all of the embodiments of the present invention. All other embodiments obtained by a person of ordinary skill in the art based on the embodiments of the present invention without creative efforts shall fall within the protection scope of the present invention.

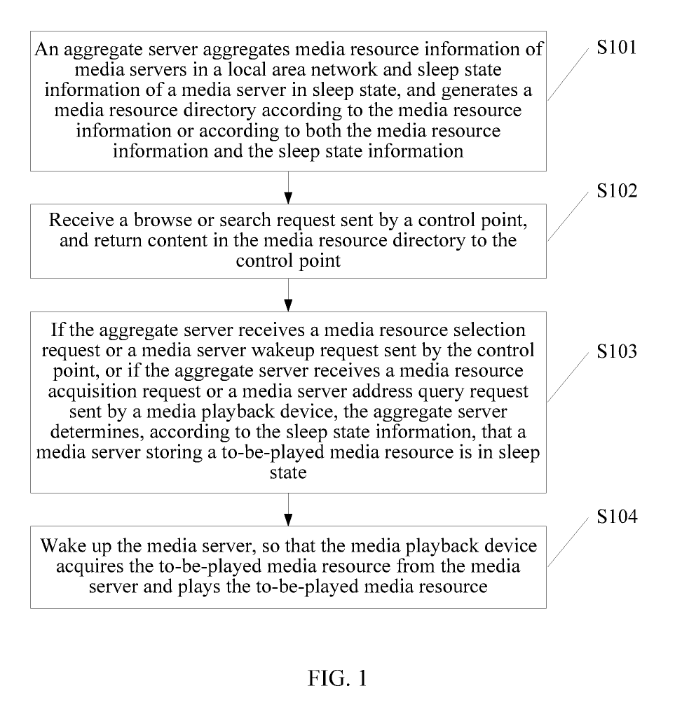

Refer to FIG. 1, which is a schematic flowchart illustrating a first embodiment of a media resource playback method according to the present invention. In this embodiment, the method includes the following steps:

S101: An aggregate server aggregates media resource information of media servers in a local area network and sleep state information of a media server in sleep state, and generates a media resource directory according to the media resource information or according to both the media resource information and the sleep state information.

The aggregate server may aggregate media resource information stored in all media servers in the local area network, and a media server sends an extended Simple Service Discovery Protocol (SSDP) message to the aggregate server before entering sleep state, where the message includes sleep state information of the media server. The media resource information includes a uniform resource identifier of a media resource.

S102: The aggregate server receives a browse or search request sent by a control point, and return content in the media resource directory to the control point.

The media resource directory includes the media resource information or includes both the media resource information and the sleep state information. When the browse or search request from the control point is received, some or all of content in the media resource directory may be returned to the control point, depending on a parameter in the browse or search request. The returned content may be the media resource information, or be both the media resource information and the sleep state information.

S103: If the aggregate server receives a media resource selection request or a media server wakeup request sent by the control point, or if the aggregate server receives a media resource acquisition request or a media server address query request sent by a media playback device, the aggregate server determines, according to the sleep state information, that a media server storing a to-be-played media resource is in sleep state.

In step S103, a triggering condition is provided for waking up the media server by the aggregate server. For example, when the control point selects a media resource and requests playing the media resource, the aggregate server, which has aggregated all media resource information and sleep state information of a media server in sleep state, may learn, according to the media resource information, a media server in which the media resource selected by the control point is located, and also may determine, according to the sleep state information, that the media server is in sleep state.

S104: The aggregate server wakes up the media server, so that the media playback device acquires the to-be-played media resource from the media server and plays the to-be-played media resource.

A manner for waking up the media server includes directly sending, by the aggregate server, a wakeup request to the media server to wake up the media server; or waking up, by the aggregate server, the media server using an out-of-band mechanism of Ethernet wakeup.

In the prior art, sleep state of a media server may be classified into multiple categories, including Transparent Sleep when the media server is in energy-saving state and can be discovered by other devices. The media server can normally send a Simple Service Discovery Protocol alive (SSDP:Alive) message, normally respond to a device search request, and be woken up by a device wakeup request; Deep Sleep Online when the media server is in energy-saving state and cannot be discovered by other devices. It cannot send an SSDP:Alive message, cannot respond to a device search request, and but it can be woken up by a device wakeup request; Deep Sleep Offline when the media server is in energy-saving state and cannot be discovered by other devices. It cannot send an SSDP:Alive message, cannot respond to a device search request, but it can be woken up in an out-of-band fashion; and Disconnect when the media server is in power-off state and cannot be discovered by other devices. It cannot send an SSDP:Alive message, cannot respond to a device search request, but it can be woken up using a vendor-defined method.

If sleep state of the media server affects information exchange by the media server, such as data transmission of a media resource, the media server must be woken up. After the media server is woken up, the media playback device can acquire the to-be-played media resource from the media server and play the to-be-played media resource.

In this embodiment, a media resource playback method is described from the perspective of an aggregate server. An aggregate server can determine, according to media resource information and sleep state information, a media server that needs to be woken up, to complete playback of a media resource.

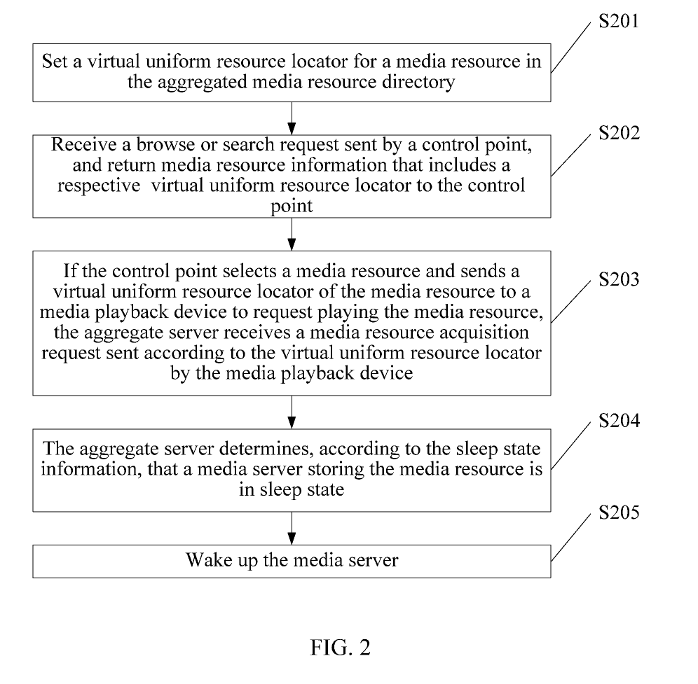

FIG. 2 is a schematic flowchart illustrating a first embodiment of a method for waking up a media server by an aggregate server according to the present invention. In this embodiment, the method includes the following steps:

S201: The aggregate server sets a virtual uniform resource locator for a media resource in an aggregated media resource directory.

A virtual uniform resource locator may be set only for a media resource in a media server in sleep state. In this case, an IP address of the virtual uniform resource locator points to the aggregate server, but an IP address of the actual uniform resource locator still points to the media server.

S202: The aggregate server receives a browse or search request sent by a control point, and return media resource information that includes a respective virtual uniform resource locator to the control point.

When a media server storing a to-be-played media resource is in sleep state, media resource information that includes a respective virtual uniform resource locator is returned; or when the media server storing the to-be-played media resource is not in sleep state, media resource information that includes an actual uniform resource locator is returned.

S203: If the control point selects a media resource and sends a virtual uniform resource locator of the media resource to a media playback device to request playing the media resource, the aggregate server receives a media resource acquisition request sent according to the virtual uniform resource locator by the media playback device.

S204: The aggregate server determines, according to sleep state information, that a media server storing the media resource is in sleep state.

S205: The aggregate server wakes up the media server.

A manner for waking up the media server includes directly sending, by the aggregate server, a wakeup request to the media server to wake up the media server; or waking up, by the aggregate server, the media server using an out-of-band mechanism of Ethernet wakeup.

In this embodiment, there is provided a method for waking up a media server by an aggregate server. Because a virtual uniform resource locator points to the aggregate server, a media playback device first requests a media resource from the aggregate server instead of directly requesting the media resource from a media server in sleep state. In this case, the aggregate server can wake up the media server according to media resource information and sleep state information, to complete subsequent playback.

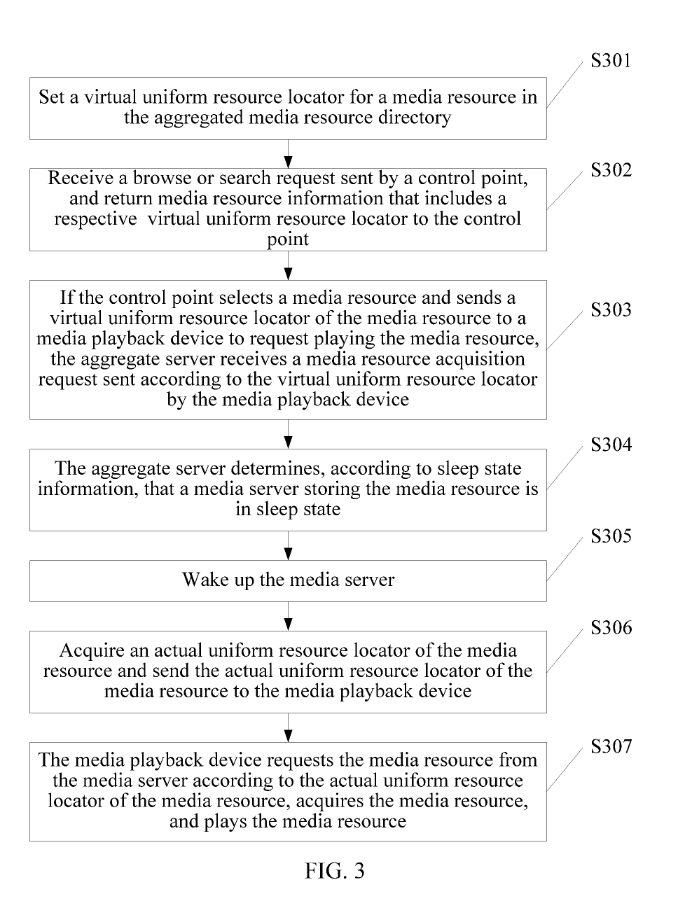

FIG. 3 is a schematic flowchart illustrating a first embodiment of a method for waking up a media server by an aggregate server and completing playback according to the present invention. In this embodiment, the method includes the following steps:

S203: The aggregate server sets a virtual uniform resource locator for a media resource in an aggregated media resource directory.

S302: The aggregate server receives a browse or search request sent by a control point, and return media resource information that includes a respective virtual uniform resource locator to the control point.

S303: If the control point selects a media resource and sends a virtual uniform resource locator of the media resource to a media playback device to request playing the media resource, the aggregate server receives a media resource acquisition request sent according to the virtual uniform resource locator by the media playback device.

S304: The aggregate server determines, according to sleep state information, that a media server storing the media resource is in sleep state.

S305: The aggregate server wakes up the media server.

S306: The aggregate server acquires an actual uniform resource locator of the media resource and sends the actual uniform resource locator of the media resource to the media playback device.

The actual uniform resource locator is pre-possessed by the media resource, and an IP address of the actual uniform resource locator points to the media server.

S307: The media playback device requests the media resource from the media server according to the actual uniform resource locator of the media resource, acquires the media resource, and plays the media resource.

This embodiment describes, from the perspective of an aggregate server, a method for waking up a media server and playing a media resource using a virtual uniform resource locator together with an actual uniform resource locator. This method exhibits is easy to set and exhibits strong stability.

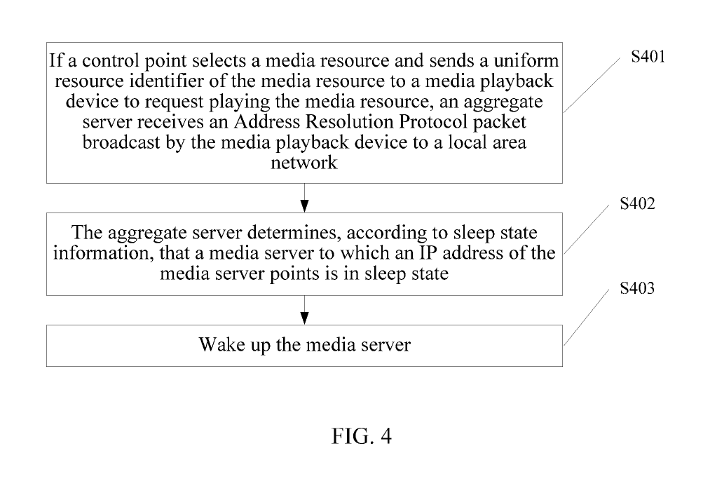

FIG. 4 is a schematic flowchart illustrating a second embodiment of a method for waking up a media server by an aggregate server according to the present invention. In this embodiment, the method includes the following steps:

S401: If a control point selects a media resource and sends a uniform resource identifier of the media resource to a media playback device to request playing the media resource, the aggregate server receives an Address Resolution Protocol packet broadcast by the media playback device to a local area network.

The Address Resolution Protocol packet is used to request a MAC address of a media server that stores the media resource, where the Address Resolution Protocol packet includes an IP address of the media playback device and an IP address of the media server.

S402: The aggregate server determines, according to sleep state information, that the media server to which the IP address of the media server points is in sleep state.

S403: The aggregate server wakes up the media server.

A manner for waking up the media server includes directly sending, by the aggregate server, a wakeup request to the media server to wake up the media server; or waking up, by the aggregate server, the media server using an out-of-band mechanism of Ethernet wakeup.

The media server has multiple sleep states. When the media server is in transparent sleep state, that is, when an IP protocol stack is working, the media server that needs to be woken up can be determined according to the IP address of the media server; or when the media server is in deep sleep state, that is, when the IP protocol stack does not work, the media server that needs to be woken up can be determined according to the MAC address of the media server acquired using the Address Resolution Protocol packet.

In this embodiment, there is provided another method for waking up a media server by an aggregate server. When a control point selects a media resource and requests playing the media resource, a media playback device broadcasts an Address Resolution Protocol packet to acquires a MAC address of a media server that stores the media resource, and determines, using an IP address or the MAC address of the media server, the media server that needs to be woken up, to complete subsequent playback.

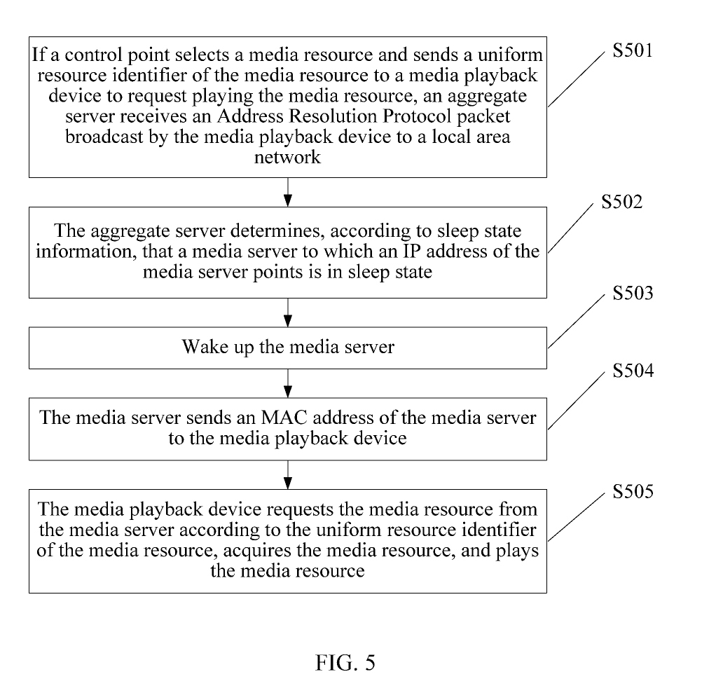

FIG. 5 is a schematic flowchart illustrating a second embodiment of a method for waking up a media server by an aggregate server and completing playback according to the present invention. In this embodiment, the method includes the following steps:

S501: If a control point selects a media resource and sends a uniform resource identifier of the media resource to a media playback device to request playing the media resource, the aggregate server receives an Address Resolution Protocol packet broadcast by the media playback device to a local area network.

The Address Resolution Protocol packet is used to request a MAC address of a media server that stores the media resource, and the Address Resolution Protocol packet includes an IP address of the media playback device and an IP address of the media server. The Address Resolution Protocol packet may further include a MAC address of the media playback device, and the aggregate server determines, according to the MAC address or IP address of the media playback device, whether the Address Resolution Protocol packet is sent by the corresponding media playback device.

S502: The aggregate server determines, according to sleep state information, that the media server to which the IP address of the media server points is in sleep state.

S503: The aggregate server wakes up the media server.

S504: The media server sends the MAC address of the media server to the media playback device.

S505: The media playback device requests the media resource from the media server according to the uniform resource identifier of the media resource, acquires the media resource, and plays the media resource.

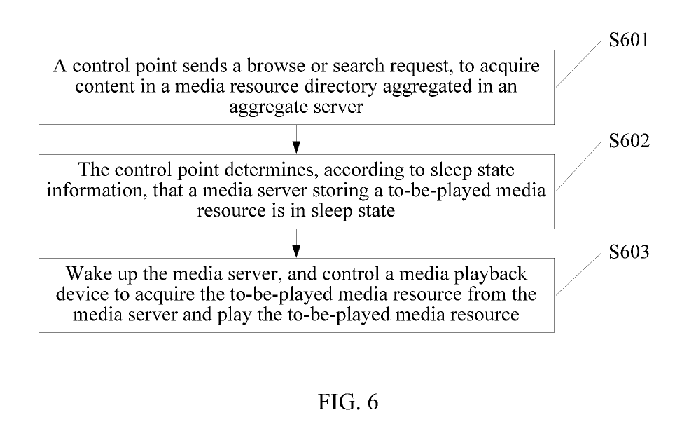

FIG. 6 is a schematic flowchart illustrating a second embodiment of a media resource playback method according to the present invention. In this embodiment, the method includes the following steps:

S601: A control point sends a browse or search request to acquire content in a media resource directory aggregated in an aggregate server.

The content in the media resource directory includes media resource information of media servers in a local area network and sleep state information of a media server in sleep state.

The browse or search request includes version information of the control point. When a version of the control point provides support for identifying the sleep state information, media resource information of all media servers is acquired; or when the version of the control point does not provide support for identifying the sleep state information, media resource information of a media server not in sleep state is acquired. This addresses the problem of a low-version control point being unable to identify a media resource directory that includes sleep state information.

S602: The control point determines, according to the sleep state information, that a media server storing a to-be-played media resource is in sleep state.

S603: The control point wakes up the media server, and controls a media playback device to acquire the to-be-played media resource from the media server and play the to-be-played media resource.

A manner for waking up the media server includes directly sending, by the control point, a wakeup request to the media server to wake up the media server; or waking up, by the control point, the media server using an out-of-band mechanism of Ethernet wakeup.

In this embodiment, there is provided a method for waking up a media server by a control point. The control point can acquire media resource information and sleep state information by sending a browse or search request, and therefore can learn a media server in which a to-be-played media resource is located and a state of the media server, and if the media server is in sleep state, wake up the media server.

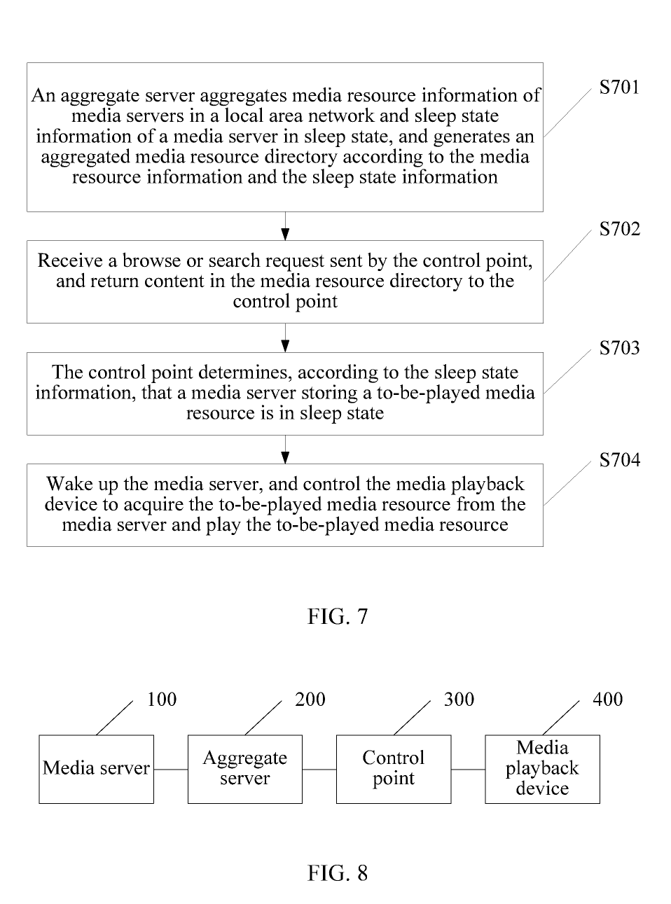

FIG. 7 is a schematic flowchart illustrating a third embodiment of a media resource playback method according to the present invention. In this embodiment, the method includes the following steps:

S701: An aggregate server aggregates media resource information of media servers in a local area network and sleep state information of a media server in sleep state, and generates an aggregated media resource directory according to the media resource information and the sleep state information.

S702: The aggregate server receives a browse or search request sent by a control point, and return content in the media resource directory to the control point.

S703: The control point determines, according to the sleep state information, that a media server storing a to-be-played media resource is in sleep state.

S704: The control point wakes up the media server, and controls a media playback device to acquire the to-be-played media resource from the media server and play the to-be-played media resource.

A manner for waking up the media server includes directly sending, by the control point, a wakeup request to the media server to wake up the media server; or waking up, by the control point, the media server using an out-of-band mechanism of Ethernet wakeup.

In this embodiment, there is provided a method for waking up a media server by an aggregate server together with a control point is given. The aggregate server is configured to aggregate media resource information and sleep state information and feed back the information to the control point, and the control point can learn, according to the information, a media server in which a to-be-played media resource is located and a state of the media server, and wake up the media server.

FIG. 8 is a schematic structural diagram of a media resource playback system according to an embodiment of the present invention. In this embodiment, the system includes a media server 100, an aggregate server 200, a control point 300, and a media playback device 400.

The media server 100 is configured to store a media resource and media resource information, where the media resource information includes a uniform resource identifier of a media resource.

The aggregate server 200 is configured to aggregate media resource information of media servers 100 in a local area network and sleep state information of a media server 100 in sleep state, and generate a media resource directory according to the media resource information or according to both the media resource information and the sleep state information; receive a browse or search request sent by the control point 300, and return the media resource directory to the control point 300; and if a media resource selection request or a media server wakeup request sent by the control point 300 is received, or if a media resource acquisition request or a media server address query request sent by the media playback device 400 is received, determine, according to the sleep state information, that a media server 100 storing a to-be-played media resource is in sleep state; and wake up the media server 100, so that the media playback device 400 acquires the to-be-played media resource from the media server 100 and plays the to-be-played media resource.

The control point 300 is configured to send a browse or search request to the aggregate server 200, acquire the media resource directory, and send a media resource selection request or a media server wakeup request to the aggregate server 200.

The media playback device 400 is configured to send a media resource acquisition request or a media server address query request to the aggregate server 200; and acquire the to-be-played media resource from the media server 100 and play the to-be-played media resource.

In order to wake up the media server 100, the aggregate server 200 is further configured to set a virtual uniform resource locator for a media resource in the aggregated media resource directory, where an IP address of the virtual uniform resource locator points to the aggregate server 200; receive a browse or search request sent by the control point 300, and return media resource information that includes a respective virtual uniform resource locator to the control point 300; and if the control point 300 selects a media resource and sends a virtual uniform resource locator of the media resource to the media playback device 400 to request playing the media resource, receive a media resource acquisition request sent according to the virtual uniform resource locator by the media playback device 400; determine, according to the sleep state information, a media server 100 storing the media resource is in sleep state; wake up the media server 100; and acquire an actual uniform resource locator of the media resource and send the actual uniform resource locator of the media resource to the media playback device 400; and the media playback device 400 is further configured to request the media resource from the media server 100 according to the actual uniform resource locator of the media resource, acquire the media resource, and play the media resource.

The media server 100 may also be woken up by broadcasting of an Address Resolution Protocol packet. In which case, the aggregate server 200 is further configured to, if the control point 300 selects a media resource and sends a uniform resource identifier of the media resource to the media playback device 400 to request playing the media resource, receive an Address Resolution Protocol packet broadcast by the media playback device 400 to the local area network, where the Address Resolution Protocol packet is used to request a MAC address of the media server 100, and the Address Resolution Protocol packet includes an IP address of the media playback device 400 and an IP address of the media server 100; determine, according to the sleep state information, the media server 100 to which the IP address of the media server 100 points is in sleep state; and wake up the media server 100; the media server 100 is further configured to send the MAC address of the media server to the media playback device 400; and the media playback device 400 is further configured to request the media resource from the media server 100 according to the uniform resource identifier of the media resource, acquire the media resource, and play the media resource.

The Address Resolution Protocol packet further includes a MAC address of the media playback device 400, and the aggregate server 200 is further configured to determine, according to the MAC address or IP address of the media playback device 400, whether the Address Resolution Protocol packet is sent by the corresponding media playback device 400.

In this embodiment, the control point 300 exists physically alone. The control point 300 may also be integrated into the aggregate server 200.

In a second embodiment, the system may still include a media server 100, an aggregate server 200, a control point 300, and a media playback device 400.

The media server 100 is configured to store a media resource and media resource information, where the media resource information includes a uniform resource identifier of a media resource.

The aggregate server 200 is configured to aggregate media resource information of media servers 100 in a local area network and sleep state information of a media server 100 in sleep state.

The control point 300 is configured to send a browse or search request to the aggregate server 200, to acquire content in a media resource directory aggregated in the aggregate server 200, where the content in the media resource directory includes the media resource information of the media servers 100 in the local area network and the sleep state information of a media server 100 in sleep state; determine, according to the sleep state information, that a media server 100 storing a to-be-played media resource is in sleep state; and wake up the media server 100, and control the media playback device 400 to acquire the to-be-played media resource from the media server 100 and play the to-be-played media resource.

The media playback device 400 is configured to receive a control command sent by the control point 300, acquire the media resource from the media server 100, and play the media resource.

The browse or search request includes version information of the control point 300. When a version of the control point 300 provides support for identifying the sleep state information, the control point 300 is configured to acquire media resource information of all media servers 100; or when the version of the control point does not provide support for identifying the sleep state information, the control point 300 is configured to acquire media resource information of a media server 100 not in sleep state.

To sum up, a manner for waking up the media server 100 includes directly sending, by the aggregate server 200 or the control point 300, a wakeup request to the media server 100 to wake up the media server 100; or waking up, by the aggregate server 200 or the control point 300, the media server 100 using an out-of-band mechanism of Ethernet wakeup.

In this embodiment, the control point 300 exists physically alone. The control point 300 may also be integrated into the aggregate server 200.

As seen from to the description of the foregoing embodiments, the present invention has the following advantages: a media server that needs to be woken up can be determined according to media resource information and sleep state information that are aggregated by an aggregate server, and is woken up by the aggregate server or a control point, to complete a corresponding playback process; a virtual uniform resource locator pointing to the aggregate server is set for a media resource so that when a media playback device requests the media resource, the aggregate server wakes up the media server and acquires an actual uniform resource locator of the media resource, to complete playback; the media playback device may acquire a MAC address of the media server by broadcasting an Address Resolution Protocol packet, and the aggregate server determines, according to an IP address or the MAC address of the media server, the media server that needs to be woken up, to complete playback; and in the event of waking up the media server by the control point, version information of the control point is added to solve the problem of a low-version control point being unable to identify a media resource directory that includes sleep state information.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a random access memory (RAM).

What is disclosed above is merely exemplary embodiments of the present invention, and is not intended to limit the protection scope of the present invention. Therefore, equivalent variations made in accordance with the claims of the present invention shall fall within the scope of the present invention.

What is claimed is:

1. A media resource playback method comprising:
aggregating, by an aggregate server, media resource information of media servers in a local area network and sleep state information of a media server in sleep state;
generating a media resource directory according to the media resource information or according to both the media resource information and the sleep state information;
receiving a browse or search request sent by a control point;
returning content in the media resource directory to the control point;
determining, by the aggregate server according to the sleep state information, that the media server storing a to-be-played media resource is in sleep state, when the aggregate server receives a media resource selection request or a media server wakeup request sent by the control point, or when the aggregate server receives a media resource acquisition request or a media server address query request sent by a media playback device; and
waking up the media server, so that the media playback device acquires the to-be-played media resource from the media server and plays the to-be-played media resource.

2. The method according to claim 1, wherein receiving the browse or search request sent by the control point and returning content in the media resource directory to the control point comprises:
setting a virtual uniform resource locator for a media resource in the aggregated media resource directory, wherein an internet protocol (IP) address of the virtual uniform resource locator points to the aggregate server;
receiving a browse or search request sent by the control point; and
returning media resource information that comprises a respective virtual uniform resource locator to the control point.

3. The method according to claim 2, wherein the media resource acquisition request received by the aggregate server is a media resource acquisition request sent according to the virtual uniform resource locator by the media playback device when the control point selects a media resource and sends the virtual uniform resource locator of the media resource to the media playback device to request playing the media resource.

4. The method according to claim 3, wherein after waking up the media server by the aggregate server, the method further comprises:
acquiring an actual uniform resource locator of the media resource; and
sending the actual uniform resource locator of the media resource to the media playback device so that the media playback device requests the media resource from the media server according to the actual uniform resource locator of the media resource, acquires the media resource, and plays the media resource.

5. The method according to claim 1, wherein the media resource information includes a uniform resource identifier of a media resource, wherein receiving, by the aggregate server, an Address Resolution Protocol packet broadcast by the media playback device to the local area network, when the control point selects a media resource and sends a uniform resource identifier of the media resource to the media playback device to request playing the media resource, wherein the Address Resolution Protocol packet is used to request a media access control (MAC) address of the media server in which the media resource is, and the Address Resolution Protocol packet comprises an IP address of the media playback device and an IP address of the media server, wherein the determining, by the aggregate server according to the sleep state information, that a media server storing a to-be-played media resource is in sleep state comprises determining, by the aggregate server according to the sleep state information, that the media server to which the IP address of the media server points is in sleep state, and wherein the waking up the media server, so that the media playback device acquires the to-be-played media resource from the media server and plays the to-be-played media resource comprises waking up the media server so that:
the media server sends the MAC address of the media server to the media playback device; and
the media playback device requests the media resource from the media server according to the uniform resource identifier of the media resource, acquires the media resource, and plays the media resource.

6. The method according to claim 5, wherein the Address Resolution Protocol packet further comprises a MAC address of the media playback device, and wherein the aggregate server determines, according to the MAC address or IP address of the media playback device, whether the Address Resolution Protocol packet is sent by the corresponding media playback device.

7. The method according to claim 1, wherein a manner for waking up the media server comprises:
sending a wakeup request to the media server to wake up the media server; or
waking up the media server by using an out-of-band mechanism of Ethernet wakeup.

8. A media resource playback method comprising:
sending, by a control point, a browse or search request, to acquire content in a media resource directory aggregated in an aggregate server, wherein the content in the media resource directory comprises media resource information of media servers in a local area network and sleep state information of a media server in sleep state;
determining, by the control point according to the sleep state information, that the media server storing a to-be-played media resource is in sleep state; and
waking up the media server, and controlling a media playback device to acquire the to-be-played media resource from the media server and play the to-be-played media resource.

9. The method according to claim 8, wherein the browse or search request comprises version information of the control point; wherein, when a version of the control point provides support for identifying the sleep state information, media resource information of all media servers is acquired, and wherein when the version of the control point does not provide support for identifying the sleep state information, media resource information of a media server not in sleep state is acquired.

10. A media resource playback method comprising:
aggregating, by an aggregate server, media resource information of media servers in a local area network and sleep state information of a media server in sleep state;
generating an aggregated media resource directory according to the media resource information and the sleep state information;
receiving a browse or search request sent by a control point; and
returning content in the media resource directory to the control point, wherein the sleep state information is used to determine, by the control point, that a media server storing a to-be-played media resource is in sleep state, so that the control point can wake up the media server, and control a media playback device to acquire the to-be-played media resource from the media server and play the to-be-played media resource.

11. A media resource playback system comprising:
a media server configured to store a media resource and media resource information;
an aggregate server configured to:
aggregate media resource information of media servers in a local area network and sleep state information of a media server in sleep state;
generate a media resource directory according to the media resource information or according to both the media resource information and the sleep state information;
receive a browse or search request sent by a control point;
return the media resource directory to the control point;
determine, according to the sleep state information, that a media server storing a to-be-played media resource is in sleep state when a media resource selection request or a media server wakeup request sent by the control point is received, or when a media resource acquisition request or a media server address query request sent by a media playback device is received; and
wake up the media server, so that the media playback device acquires the to-be-played media resource from the media server and plays the to-be-played media resource;
the control point configured to send a browse or search request to the aggregate server, acquire the media resource directory, and send the media resource selection request or the media server wakeup request to the aggregate server; and
the media playback device configured to send the media resource acquisition request or the media server address query request to the aggregate server; and acquire the to-be-played media resource from the media server and play the to-be-played media resource.

12. The system according to claim 11, wherein the aggregate server is further configured to:
set a virtual uniform resource locator for a media resource in the aggregated media resource directory, wherein an internet protocol (IP) address of the virtual uniform resource locator points to the aggregate server;
receive a browse or search request sent by the control point, and
return media resource information that comprises a respective virtual uniform resource locator to the control point; and
receive, by the aggregate server, a media resource acquisition request sent according to the virtual uniform resource locator by the media playback device when the control point selects a media resource and sends the virtual uniform resource locator of the media resource to the media playback device to request playing the media resource;
determine, according to the sleep state information, that a media server storing the media resource is in sleep state;
wake up the media server; and
acquire an actual uniform resource locator of the media resource and send the actual uniform resource locator of the media resource to the media playback device; and wherein the media playback device is further configured to:
request the media resource from the media server according to the actual uniform resource locator of the media resource;
acquire the media resource; and
play the media resource.

13. The system according to claim 11, wherein the media resource information includes a uniform resource identifier of a media resource, and wherein the aggregate server is further configured to:
receive, by the aggregate server, an Address Resolution Protocol packet broadcast by the media playback device to the local area network, when the control point selects a media resource and sends a uniform resource identifier of the media resource to the media playback device to request playing the media resource, wherein the Address Resolution Protocol packet is used to request a media access control (MAC) address of the media server, and wherein the Address Resolution Protocol packet comprises an IP address of the media playback device and an internet protocol (IP) address of the media server;
determine, according to the sleep state information, that the media server to which the IP address of the media server points is in sleep state; and
wake up the media server, wherein the media server is further configured to send the MAC address of the media server to the media playback device, and wherein the media playback device is further configured to:
request the media resource from the media server according to the uniform resource identifier of the media resource;
acquire the media resource and
play the media resource.

14. The system according to claim 13, wherein the Address Resolution Protocol packet further comprises a MAC address of the media playback device, and the wherein aggregate server is further configured to determine, according to the MAC address or IP address of the media playback device, whether the Address Resolution Protocol packet is sent by the corresponding media playback device.

15. The system according to claim 11, wherein a manner for waking up the media server comprises:
sending a wakeup request to the media server to wake up the media server; or
waking up the media server by using an out-of-band mechanism of Ethernet wakeup.

16. The system according to claim 11, wherein the control point exists physically alone or is integrated into the aggregate server.

17. A media resource playback system comprising:
a media server configured to store a media resource and media resource information;
an aggregate server configured to aggregate media resource information of media servers in a local area network and sleep state information of a media server in sleep state;
a control point configured to:
send a browse or search request to the aggregate server, to acquire content in a media resource directory aggregated in the aggregate server, wherein the content of the media resource directory comprises the media resource information of the media servers in the local area network and the sleep state information of the media server in sleep state;
determine, according to the sleep state information, that the media server storing a to-be-played media resource is in sleep state;
wake up the media server; and
control a media playback device to acquire the to-be-played media resource from the media server and play the to-be-played media resource; and
the media playback device configured to receive a control command sent by the control point, acquire the media resource from the media server, and play the media resource.

18. The system according to claim 17, wherein the browse or search request comprises version information of the control point; wherein, when a version of the control point provides support for identifying the sleep state information, the control point is configured to acquire media resource information of all media servers, and wherein, when the version of the control point does not provide support for identifying the sleep state information, the control point is configured to acquire media resource information of a media server not in sleep state.

19. The system according to claim 17, wherein waking up the media server comprises:
sending a wakeup request to the media server to wake up the media server; or
waking up the media server using an out-of-band mechanism of Ethernet wakeup.

20. The system according to claim 17, wherein the control point exists physically alone or is integrated into the aggregate server.
